(19) United States
(12) Patent Application Publication
(10) Pub. No.: US 2026/0251138 A1
(43) Pub. Date: Aug. 27, 2026

(54) HYDRAULIC MECHANICAL PUMPING UNIT WITH A VENTILATION DUCT FOR ELECTRONIC COMPONENTS AND A DAMPING FILTRATION SYSTEM

(71) Applicant: Alejandro Ladron De Guevara, Colombia (CO)

(72) Inventor: Alejandro Ladron De Guevara, Colombia (CO)

(21) Appl. No.: 19/161,559

(22) PCT Filed: Mar. 4, 2024
(86) PCT No.: PCT/IB2024/052085

§ 371 Date: Sep. 2, 2025

(30) Foreign Application Priority Data
Mar. 2, 2023 (CO) NC2023/0002679

(51) Int. Cl. F04B 53/08; F04B 17/03; F04B 53/20

(52) U.S. Cl. CPC F04B 53/08; F04B 17/03; F04B 53/20

(57) ABSTRACT

The invention relates to a hydraulic unit for mechanical pumping with a ventilation duct for electronic components and a dampened filtration system, which performs the task of supplying a given flow of pressurized hydraulic oil to a hydraulic actuator. The actuator in turn lifts a load equivalent to the weight of the rod string plus the weight generated by the hydrostatic column present in the discharge of a mechanical pump located at the bottom of the oil well. The main feature of this hydraulic mechanical pumping unit is that it comprises a ventilation duct, which diverts part of the air entering the unit and redirects it to the rear side of the electrical box. This achieves cooling of all the electrical and electronic components of the unit, without the need for additional motor-fans.

### FIELD OF THE INVENTION

The present invention relates to a hydraulic unit for mechanical pumping with a ventilation duct for electronic components and a dampened filtration system, perfected for use in the production or extraction of hydrocarbons.

In the oil industry, it is known that oil wells must be produced at different speeds and forces, given that reserves progressively decline over time. Consequently, oil deposits are increasingly found at greater depths. Therefore, the present invention comprises applicability in oil wells where mechanical pumping is used as an artificial lift system, particularly in deep wells requiring long-stroke equipment, high forces, and great operational stability.

### BACKGROUND OF THE INVENTION

Hydraulic mechanical pumping units are machines that perform artificial lift of oil from the subsoil by means of a hydraulic system composed of several independent elements. Generally, three motors are used: one for the power pump, another for the recirculation pump, and another for a fan. These machines also include an oil tank, a radiator, an electrical box (containing several motor-fans to cool electrical and electronic components), an air duct to direct the fan, and a frame or chassis in which all the components are mounted.

The present invention simplifies the design and optimizes the operation of the conventional hydraulic unit, since it uses a single motor to drive both the hydraulic pump and the fan (the fan provides the necessary air to cool the hydraulic oil and the electrical and electronic components located inside the electrical box). In addition, its physical structure provides two hydraulic tanks, a radiator, an air guide, and a ventilation duct; all of these components are integrated into or fused with the chassis of the unit, resulting in a more reliable and simpler machine requiring less maintenance.

In the state of the art, two patents comprise been granted to Serinpet Ltda. in Colombia:
Hydraulic unit for mechanical pumping with a single motor-Resolution No. 10544
Hydraulic unit for mechanical pumping with integrated radiator-Resolution No. 29603

These inventions comprise also been recognized as patents in the following countries:
United States-U.S. Pat. No. 13/880,734-U.S. Pat. No. 10,563,490
Canada-CA2,815,4396-CA2815439
Argentina-P110103850-AR083470B1
Brazil-BR112013009806-BR112013009806-6
Mexico-MX/a/2013/004497-MX348517
China-ZL 2011800564780-ZL 2011800564780
United States-U.S. Pat. No. 15/037,933-U.S. Pat. No. 2017,122,310
Canada-CA2,934,855-CA2934855
Australia-AU2014411549-AU2014411549
Brazil-BR112016011464-BR112016011464
Mexico-MX/a/2016/006687-MX2016006687
China-CN2014800777719-CN106170604
Russia-RU2016146167-RU2016146167
Saudi Arabia-SA516371171-SA516371171
United Arab Emirates-AUE2016/618-AUE2016/617
Malaysia-PI2016000945-PI2016000945
Iran-139550140003003651-139550140003003651

This invention introduces two key improvements: (i) with the same motor and fan, both the hydraulic oil and the rear of the electrical box are cooled, ensuring all electronic components are protected without the inclusion of additional fans or mechanisms; and (ii) efficient use of air by filtering it through labyrinth-type air filters and directing it into a ventilation duct attached to the rear of the electrical box, achieving heat transfer and cooling of all electronic components.

Additionally, this unit improves the operational condition of the hydraulic oil by simultaneously cooling and filtering it through cyclic microfiltration and a hydraulic damper submerged in the return tank oil, balancing pressure peaks with a piston-based mechanism. This increases the service life of filters and the entire system.

Other similar inventions, such as patents U.S. Pat. No. 6,739,129 and ES2314009, comprise multiple motors and other configurations that do not correspond to the simplicity and integration of the present invention. For example, ES2314009 discloses a fan associated with a motor without emphasizing its role in the overall design, and U.S. Pat. No. 6,739,129 discloses a fan connected to an electromotor without reference to electronic components or a dampened filtration system.

Therefore, the present invention provides a more stable and reliable unit, with cleaner oil, lower operating temperature protecting electronic components, and reduced maintenance requirements.

### DESCRIPTION OF THE DRAWINGS

FIG. 1. Perspective view of the hydraulic power unit, pedestal, and hydraulic actuator. With detail A of the upper limit switch sensor (5), high-pressure hose (2), and detail B of the lower limit switch sensor (6).

FIG. 2. Perspective view of the hydraulic power unit (1).

FIG. 3. Perspective view of the powertrain of the hydraulic power unit (1).

FIG. 4. Side view of the hydraulic power unit (1) showing airflow entering it and then being distributed between the radiator (35) and the ventilation duct for electronic components (12).

FIG. 5. Perspective and side view of the hydraulic damper (23), showing all external and internal components.

FIG. 6. Perspective and side view of the hydraulic actuator (4), showing all external and internal components.

FIG. 7. Perspective and side view of the labyrinth-type air filters (32), showing how the airflow makes two changes of direction.

FIG. 8. Hydraulic diagram.

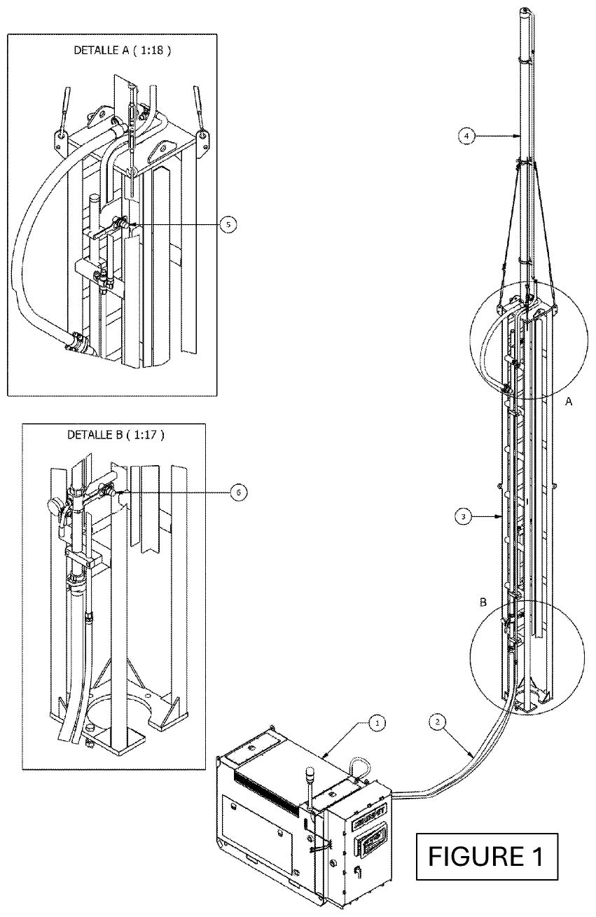

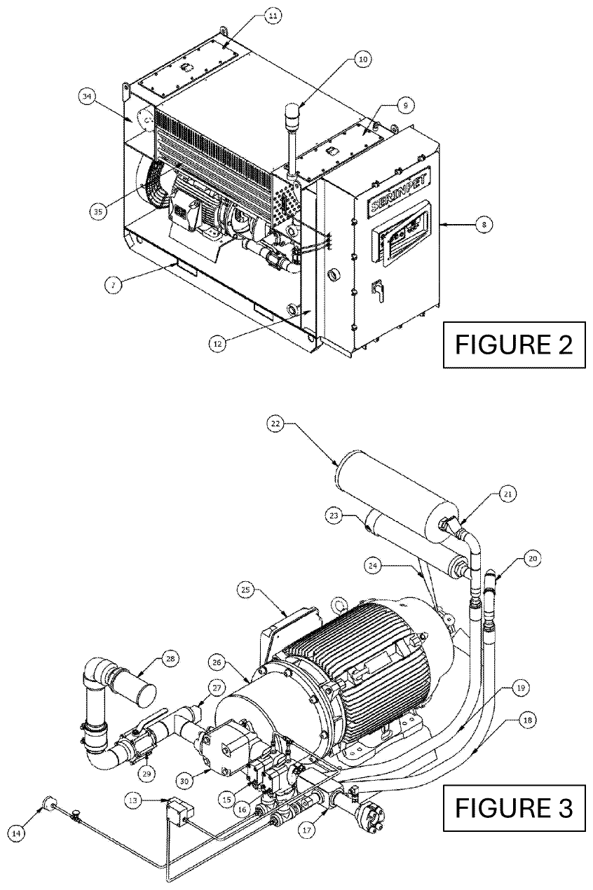

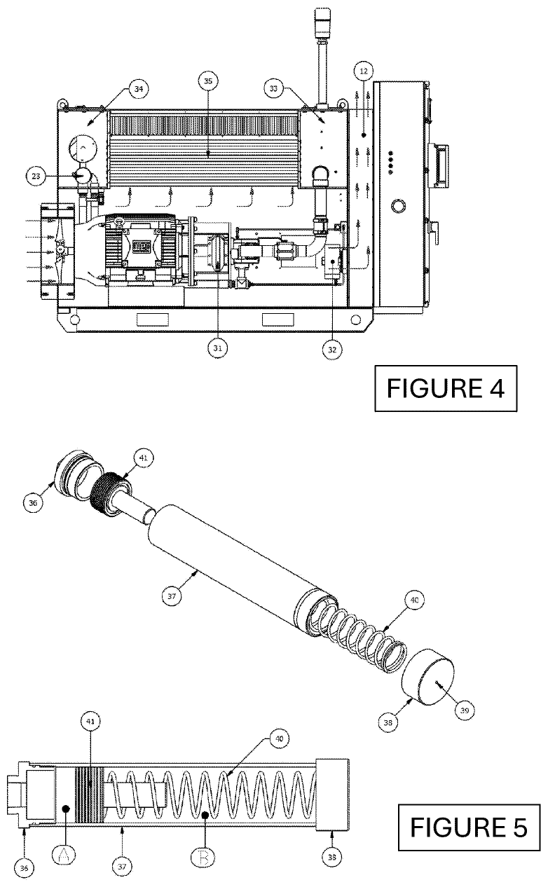

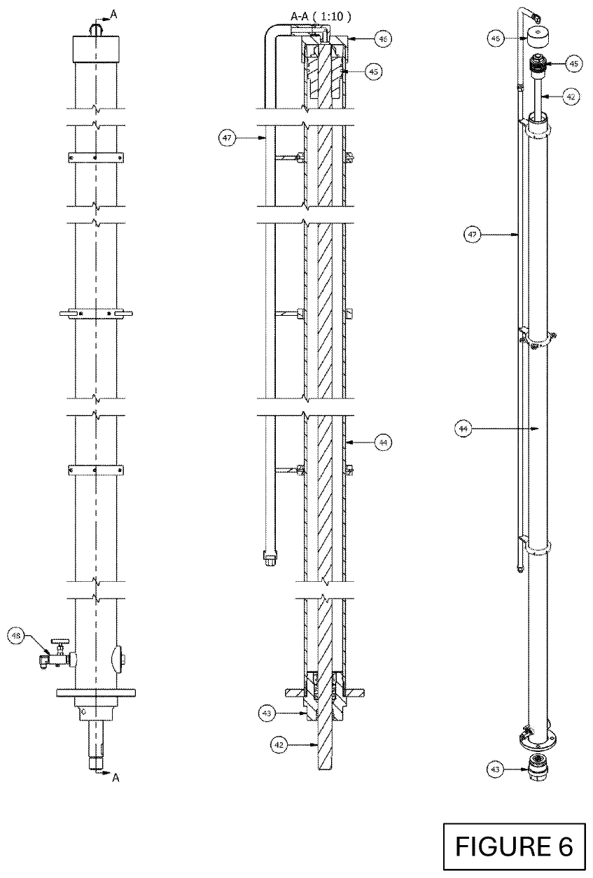

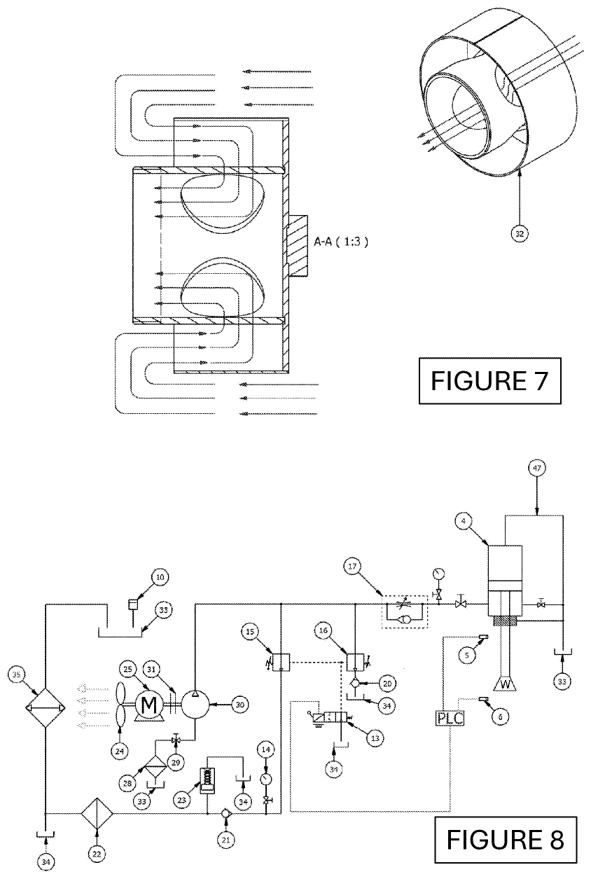

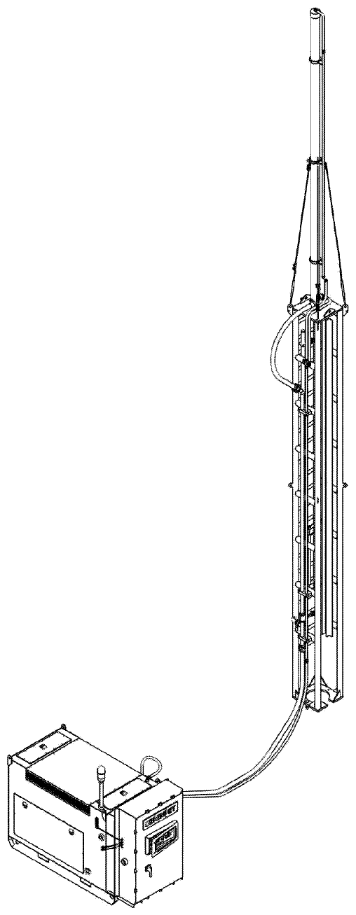

### REFERENCE LIST

1. Hydraulic power unit
2. High-pressure hose
3. Pedestal
4. Hydraulic actuator (hereinafter also referred to as a hydraulic cylinder)
5. Upper limit switch sensor
6. Lower limit switch sensor
7. Chassis
8. Electrical box
9. Suction tank cover
10. Air filter
11. Return tank cover
12. Ventilation duct for electronic components
13. Solenoid valve
14. Return line pressure gauge
15. Recirculation pressure-regulating valve
16. Hydraulic actuator return line pressure control valve
17. Throttle check valve
18. Return hose from hydraulic actuator
19. Recirculation return hose
20. Hydraulic actuator return line check valve
21. Recirculation return line check valve
22. Recirculation oil filter
23. Hydraulic damper
24. Fan
25. Motor
26. Bell housing
27. Thermostat
28. Suction oil filter
29. Suction ball valve of the hydraulic pump
30. Hydraulic pump
31. Flexible coupling
32. Labyrinth-type air filter
33. Suction tank
34. Return tank
35. Radiator
36. Hydraulic damper front cover
37. Hydraulic damper casing
38. Hydraulic damper rear cover
39. Orifice of the hydraulic damper rear cover
40. Damper spring
41. Damper piston
42. Hydraulic actuator rod
43. Hydraulic actuator lower bushing cap
44. Hydraulic actuator casing
45. Hydraulic actuator piston
46. Hydraulic actuator top cover
47. Low-pressure return line of hydraulic actuator oil
Chamber A-Chamber B

### DETAILED DESCRIPTION OF THE INVENTION

The hydraulic mechanical pumping unit with ventilation duct for electronic components and dampened filtration system comprises a hydraulic power unit (1) that cyclically supplies pressurized hydraulic oil to a hydraulic actuator (4) (hereinafter also referred to as a hydraulic cylinder), which lifts the load equivalent to the weight of the rod string plus the weight of the fluid to be extracted from the subsoil.

A motor (25) is coupled to a hydraulic pump (30) via a flexible coupling (31). This pump suctions oil from the suction tank (33) and delivers a specific flow of pressurized oil to the pressure-regulating valves (15 and 16), which are piloted by a directional valve or solenoid valve (13). When the solenoid valve (13) is closed, the pressure-regulating valves (15 and 16) remain closed, sending oil to the hydraulic actuator (4) via a high-pressure hose (2) connecting the hydraulic power unit (1) to the pedestal (3).

Once the oil enters the hydraulic actuator (4), it induces an upward force on the effective area of the actuator piston (45). This piston transmits the force to the rod (42), which is connected to the rod string. This produces the upward stroke of the rod string, resulting in the extraction of a certain volume of fluid from the well.

When the actuator (4) comprises retracted the rod (42) to its highest position, an upper limit switch sensor (5) detects this condition and sends a signal to a PLC, which switches off the solenoid valve (13), causing it to open. This, in turn, opens the pressure-regulating valves (15 and 16), so that the oil delivered by the hydraulic pump (30) returns to the return tank (34) through the first pressure-regulating valve (15), forcing it to pass through the oil recirculation filter (22). This filter is protected against structural fractures by a hydraulic damper (23), which is immersed in the hydraulic oil inside the return tank (34).

A second pressure-regulating valve (16), also piloted by the same solenoid valve (13), redirects the remaining oil inside the hydraulic actuator to the return tank (34). Between the second pressure-regulating valve (16) and the hydraulic actuator (4) is located a throttle check valve (17), which restricts the return flow of oil from the hydraulic actuator (4) in order to regulate the downward velocity of the actuator rod (42) and, consequently, the descent speed of the rod string.

The actuator rod (42) thus descends until it reaches a lower limit switch sensor (6), which sends a new signal to the PLC, causing it to energize the solenoid valve (13). The valve then closes again, closing both pressure-regulating valves (15 and 16), and restarting the cycle.

Throughout the operation, the motor (25) rotates continuously, so the hydraulic pump (30) always delivers oil, either to the actuator (4) or returning it to the return tank (34).

In addition, the motor (25) of the hydraulic mechanical pumping unit with ventilation duct and dampened filtration system comprises a through shaft. Since the hydraulic pump (30) is installed on the front shaft end, at the opposite end of the shaft a fan (24) is installed. This fan provides a constant airflow inside the hydraulic power unit (1), configured to cool both the hydraulic oil and the unit's electrical and electronic components.

Approximately 90% of the airflow is forced through the radiator (35), cooling the hydraulic oil. The remaining 10% is directed through labyrinth-type air filters (32) before entering the ventilation duct (12).

The ventilation duct (12) is located in the front area of the hydraulic power unit (1) and is attached to the rear of the electrical box (8). Inside this electrical box (8) are the electrical and electronic components required for proper operation, such as a PLC, soft starter, power switches, frequency inverters, and power supplies. These elements emit heat, which must be dissipated by constant airflow. Because the air supplied by the fan (24) may contain contaminants such as dust or soil, labyrinth-type air filters (32) are installed at the ventilation duct inlet (12), thereby preventing clogging of the duct and ensuring clean airflow.

The labyrinth-type air filters (32) are designed to force the airflow into two directional changes. At these turns, particles or contaminants entrained by the air lose velocity and fall outside the duct, preventing contamination inside the electrical box.

Constructively, the chassis (7) integrates the suction tank (33), the return tank (34), and the radiator (35), forming a single hydraulic oil reservoir. This configuration allows oil to flow from the return tank (34) to the suction tank (33) through the radiator (35) using the principle of communicating vessels.

Inside the return tank (34) are the oil recirculation filter (22) and the hydraulic damper (23). When the pressure-regulating valves (15 and 16) open, they suddenly return oil to the tank, generating a transient pressure peak known as water hammer. This peak is first absorbed by the hydraulic damper (23), which attenuates it, thereby protecting the structural integrity of the oil recirculation filter (22).

The hydraulic damper (23) comprises an internal piston (41) and a spring (40), which define two separate chambers. At the front end is chamber A, and at the rear of the piston (41), together with the spring (40), is chamber B. Being submerged in the oil of the return tank (34), both chambers remain filled with hydraulic oil.

The damper (23) operates as follows: when the pressure-regulating valves (15 and 16) open, they induce a transient pressure peak in the return lines (18 and 19). At the end of the return hose (19) is the hydraulic damper (23). Thus, the piston (41) receives the pressure peak on its front face, causing a rearward movement that compresses the spring (40) while expelling oil from chamber B through the small orifice (39) in the rear cover of the damper. In this way, the transient pressure peak is eliminated.

The damping effect of the water hammer is mainly generated by the hydraulic oil expelled from chamber B through the orifice (39). The spring (40) primarily functions to reposition the piston (41) once the valves (15 and 16) close again. This refills chamber B with hydraulic oil, preparing the damper (23) for the next transient pressure peak.

1. A hydraulic mechanical pumping unit with a ventilation duct for electronic components and a dampened filtration system, comprising a ventilation duct (12) which diverts a fraction of the air entering the unit to cool the electrical and electronic components located inside an electrical box (8).

2. The hydraulic mechanical pumping unit with a ventilation duct for electronic components and a dampened filtration system according to claim 1, comprising labyrinth-type air filters (32) that protect the ventilation duct (12) from clogging by contaminant particles by changing the direction of the airflow more than once.

3. The hydraulic mechanical pumping unit with a ventilation duct for electronic components and a dampened filtration system according to claim 1, comprising a single motor (25) that provides the necessary power to cyclically drive a hydraulic actuator (4), cool the hydraulic oil contained therein, and simultaneously refrigerate the electrical and electronic components of said unit.

4. The hydraulic mechanical pumping unit with a ventilation duct for electronic components and a dampened filtration system according to claim 1, comprising a hydraulic damper (23) submerged in the return tank (34), which uses the same hydraulic oil of the unit to load and unload chamber B, directing the hydraulic oil through the orifice (39) of the rear cover (38) of the hydraulic damper.
